(19) United States
(12) Patent Application Publication
(10) Pub. No.: US 2024/0361198 A1
(43) Pub. Date: Oct. 31, 2024

(54) CONTACTLESS DEVICE FOR GENERATING COMPRESSION OR TENSION STEPS

(71) Applicant: COMMISSARIAT A L'ENERGIE ATOMIQUE ET AUX ENERGIES ALTERNATIVES, Paris (FR)

(72) Inventor: Maylis LAVAYSSIERE, Faycelles (FR)

(73) Assignee: COMMISSARIAT A L'ENERGIE ATOMIQUE ET AUX ENERGIES ALTERNATIVES, Paris (FR)

(21) Appl. No.: 18/646,254

(22) Filed: Apr. 25, 2024

(30) Foreign Application Priority Data
Apr. 26, 2023 (FR) 2304237

(51) Int. Cl. G01L 25/00

(52) U.S. Cl. CPC G01L 25/00

(57) ABSTRACT

A device including a sensor capable of carrying out dynamic force or mass measurements, for example a force sensor, including a magnetic device to generate a magnetic field according to at least one axis (XX′), a device to adjust and then hold a relative position, according to the axis (XX′), between a force sensor to be tested and the magnetic device, and a device to measure a signal representative of a tensile or compressive force applied to a contactless force sensor, directly using the magnetic device.

### TECHNICAL FIELD AND PRIOR ART

The invention relates to the field of metrology for sensors, in particular force sensors, for dynamic testing and/or characterization and/or calibration thereof.

For example, it allows generating compression or tension steps in a contactless fashion, for example for a static in-situ calibration of force sensors and/or for a dynamic calibration.

In particular, it allows finding the transfer function of the measurement chain. There are currently 3 methodologies in the literature to dynamically qualify force sensors. First of all, there is the shock method by impact generated by a shock hammer, which generates “pulse”-type signals. This method is adapted to force sensors with a wide measurement range and its implementation, which requires the use of interferometers for measuring acceleration, makes the in-situ aspect difficult, even though efforts are made to work on an embedded system, as described in the article by N. Vlajic and A. Chijioke, “Traceable calibration and demonstration of a portable dynamic force transfer standard,” published in Metrologia, vol. 54, no. 4, pp. S83-S98, 2017 Jul. 18 2017. There is also the sinusoidal excitation method, which subjects the sensor to periodic oscillations, by connecting the end of the latter to a vibrating vessel; in this respect, reference may be made to the article by C. Schlegel et al., “Traceable periodic force calibration”, Metrologia, vol. 49, no. 3, pp. 224-235, 2012 Mar. 12 2012.

Finally, there is also a force step generation method which could be done by the so-called “knife” or “cut-wire” method, wherein the sensor is subjected to a compressive or tensile force using a wire connected to a known mass allowing applying a known force. When cutting the wire, the system returns to its equilibrium state after having been subjected to a step considered as perfect. The frequency response of the measurement chain is obtained.

A generic method suggests combining the 3 calibration types described before. It is based on the principle of a mass set in levitation (Levitation Mass Method LMM) above a force sensor through the use of the pressure of an air column or of a magnetic field, as described by Y. Fujii and A. Takita, in the article entitled “Correction method for force transducers on dynamic condition with or without the Levitation Mass Method (LMM)”, published in Procedia Engineering, vol. 32, pp. 13-17, 2012 Jan. 1/2012. This method uses the inertial force generated by the mass which hits the sensor, obtained by the product of the mass by its acceleration. Depending on the experimental configuration, the previous 3 load types may be obtained.

One could find in the literature (cf. for example the article by D. B. Newell et al. “The NIST Microforce Realization and Measurement Project”, Instrumentation and Measurement, IEEE Transactions on Instrumentation and Measurement, vol. 52, pp. 508-511, May 1, 2003) loads that are not based on a mechanical force, but on an electrostatic force: this consists in applying force steps within a range from nN to UN, and in a static calibration context.

In general, there is no method that does without an implementation by direct contact, which generates a disturbance of the measurement. In particular, in the case of the technique of cutting a wire with a blade, a given amount of wire remains hooked to the sensor and is set in motion, which distorts the equilibrium position. In addition, this technique requires the implementation of a force perpendicular to the wire (to actuate the cutting blade) which, herein again, generates a biasing force which is disturbing. 3 problems related to this technique are discussed later on in this application. As regards the other aforementioned techniques, these are complex to implement: they require the presence of an operator and a modification of the experimental system when it is desired to modify the implemented forces or stresses and cannot, in particular, be carried out in situ, on a measurement site and outside a laboratory. In addition, a technique that could be implemented over a large working range, for example in the range from 1/100^{th} Newton to over one Newton (N), is desired.

### DISCLOSURE OF THE INVENTION

The invention aims to solve all or part of the problems set out hereinabove or in the remainder of the present application.

The invention primarily relates to a device for testing and/or calibrating and/or characterizing the transfer function of a sensor (for example a force sensor), including:
magnetic means for generating a magnetic field according to at least one axis (XX′), for example an electromagnet;
means for adjusting and then holding and/or measuring a relative position, according to the axis (XX′), between a sensor to be tested and the magnetic means;
means for measuring a signal representative of a tensile or compressive force applied to the sensor directly using said magnetic means;
possibly means for measuring a signal representative of the setpoint applied to the magnetic means, for example, the power supply current and/or voltage of the magnetic means.

According to one embodiment, the means for generating a magnetic field include an electromagnet.

Preferably, a device according to the invention further includes means for reversing the direction of application of the magnetic field along the direction (XX′), for example means for:
reversing the direction of circulation of the current in an electromagnet, enabling the generation of a tensile or compressive force; these means then serve as an actuator;
and/or for cutting off the application of the magnetic field along the axis (XX′); these means then serve as a switch.

According to an exemplary embodiment, a device according to the invention further includes means, for example mechanical means, for limiting the distance between the magnetic means and a sensor to a minimum distance. Thus, the measurement chain may be secured.

The device according to the invention may also include means for adjusting and holding and/or measuring a relative position, according to the axis (XX′), between a sensor to be tested and the magnetic means, may include at least one motor, for example a stepper motor.

The device according to the invention may also include motors, for example stepper motors, according to at least 2 axes, for example the axes (YY′) and (ZZ′), to center the sensor to be characterized and the magnetic means.

According to one embodiment, the movable support is driven by a 3-axis system controlled by 3 motors.

A device according to the invention may further include:
means for centering and/or holding and/or measuring a relative position according to the axes (YY′) and (ZZ′) between the sensor to be characterized and the magnetic means;
and/or means for measuring and/or digitizing and/or processing a signal sampled at the terminals of a sensor tested or characterized using the device according to the invention, for example means for carrying out a Fourier transform of said signal;
and/or means for measuring and/or digitizing and/or processing a signal sampled at the terminals of the voltage or current setpoint of the magnetic means generating the load using the device according to the invention, for example of the power supply system of the magnetic means;
and/or means for memorizing response and/or calibration and/or hysteresis data of a sensor.

The invention also relates to a method for testing and/or calibrating and/or characterizing a sensor, for example a force sensor, for example implementing a device as described hereinabove and in the remainder of the present application.

Such a method for testing and/or calibrating and/or characterizing a sensor may include the following steps:
fixedly holding said sensor with respect to means for generating a magnetic field;
possibly, positioning (or centering) said sensor with the magnetic means;
generating a magnetic field (B) enabling the application of a stress, for example a tension or a compression, on the sensor, by direct interaction between this field and the sensor;
measuring and/or recording and/or digitizing the response of the sensor to this stress, for example in tension or compression;

possibly measuring and/or recording and/or digitizing driving of the magnetic means.

A method according to the invention may further include a step of mounting an accessory, for example a ring, on the sensor.

Such a method may include a prior step of mounting a magnetic part on the accessory. In a method according to the invention, it is possible to alternately apply a tensile and then compressive force or stress (or vice versa) to the sensor by reversing the magnetic field, for example by reversing the direction of circulation of a current in an electromagnet that generates said magnetic field.

If the body of the sensor is nonmagnetic, the method may include a prior step of mounting a magnetic part on or in the sensor, for example, a screw. It should be noted that the added magnetic part is preferably selected compatible with the measurement range of the sensor.

A method according to the invention may further include modifying or adjusting the spacing between the means for generating a magnetic field and said sensor. Thus, it is possible to carry out measurements for different distances between the sensor and the means for generating a specific force via the magnetic field.

A method according to the invention may include applying to the sensor:
a tensile stress and then a compressive stress;
or a tensile or compressive stress, and then no stress (the sensor then being at rest). The tensile or compressive stress may be applied according to a 1^{st} axis of sensitivity of the sensor, preferably while limiting the transverse forces perceived by the sensor. If the sensor includes at least one 2^{nd} axis of sensitivity, the method may further include a step of modifying the orientation of the sensor, and applying a tension or a compression at least according to this 2^{nd} axis of sensitivity of the sensor.

For example, a method according to the invention may be applied to a sensor capable of carrying out a dynamic weight or mass measurement, for example a one-axis or three-axis piezoresistive, or piezoelectric or capacitive type force sensor, or a sensor including a scale or a weighing machine.

This method according to the invention may be extended for example to a sensor capable of carrying out a dynamic mass measurement, for example a scale or a weighing machine. For example, a sensor to which the invention could be applied may include one or more face(s), the magnetic field being applied according to a direction perpendicular to this or these face(s).

A method according to the invention may further include a step of memorizing data on the temporal variation of the response of the sensor from an initial state, when subjected to said stress, for example said tension or compression, according to a position of the sensor with respect to means that generate said magnetic field (B), until passage thereof into a final state, which may be the sensor at rest or the sensor according to a stress, for example tensile or compressive, different from its initial state, according to a new position of the sensor with respect to means that generate said magnetic field (B). For example, such data are response and/or calibration and/or hysteresis qualification data of the sensor.

A device according to the invention or a method according to the invention allows dynamically testing and/or characterizing an/or calibrating a force sensor (the response of the sensor is measured over time) by applying one or more successive stress(es), for example by generating one or more force step(s) (for example with a return to its rest or stressed initial state), the amplitude of which is controlled by application of a magnetic field directly on the sensor and without any contact with the latter.

In particular, this contactless load allows finding the transfer function of the tested sensor, and/or of the measurement chain in its entirety, for example with means for acquiring and/or processing the signal, in the work environment of the sensor, while taking account of the possible mechanical couplings, for example, when an accessory support should be mounted on the sensor for the experiment needs.

The static phase of a step generated by application of a magnetic field that is constant over time also allows statically calibrating the force sensor: for the application of a given field, for example according to the distance between the magnetic means and the sensor, it is possible to measure the sensitivity of the sensor.

A device or a method according to the invention allows generating a step or a stress with a magnetic field, but also being able to test a sensor in tension and/or in compression (for example in tension at first, and then in compression, or vice versa) by adapting the orientation of the magnetic field, for example the polarity of the electromagnet: no modification or interference is necessary with the experimental mounting set. In addition, this calibration may be carried out on an experimentation site, and not only in the laboratory.

A device or a method according to the invention allows loading according to one direction a sensor with one component (1 axis of sensitivity) or more, for example 3 components (for example 3 axes of sensitivity) subject to the modification of the orientation of the sensor for characterization and/or calibration of each axis.

In a method or a device according to the invention, in tension or in compression, the sensor may be:
subjected to a stress or a force within a wide range, for example comprised between 1/10 Newton and 1 Newton and more than 1 N, for example up to 5 N (depending on the means for generating a magnetic field, the method or the device according to the invention may be used within wider ranges; if the electromagnet is changed, it is possible to verify that the latter generates a sufficiently high field, and possibly that, when its power supply is cut, it releases the sensor preferably within a time period shorter than the response time of the sensor, in order to best excite in the bandwidth of the sensor, preferably in the entirety of this bandwidth;
and/or loaded over the measurement range of the sensor, but also in loading-unloading, without any mechanical intervention of the operation.

For example, the invention allows characterizing, and possibly calibrating, for example a force sensor like a dynamic mass measuring sensor, for example to assess the mass loss of a material subjected to a heat flow.

The invention is compact and can be carried by the users on the experimental sites. It allows limiting heat exchanges, for example thanks to an integral cowling. It also allows isolating the measurement chain from possible parasites related to vibrations, for example thanks to its support, including for example anti-vibration pads.

### BRIEF DESCRIPTION OF THE FIGURES

FIGS. 1A and 1B show 2 exemplary embodiments of a device according to 2 embodiments of the invention;

FIG. 2A shows a device according to an embodiment of the invention, equipped with its measurement chain;

FIG. 2B shows another aspect of the measurement chain for a device according to an embodiment of the invention;

FIG. 3A shows on the one hand the setpoint applied to the electromagnet and the oscillatory response of the system to be characterized;

FIG. 3B shows a transfer function of a measurement chain;

FIG. 4A, FIG. 4B, FIG. 4C and FIG. 4D show the comparison of temporal signals (FIGS. 4A and 4C) and their frequency response (FIGS. 4B and 4D) for compression and tension type load.

FIGS. 5A-5B show temporal signals obtained for a compressive (FIG. 5A) or tensile (FIG. 5B) load.

FIG. 6 shows the evolution of the mass variation as seen by a sensor (as a function of the movement of the motors) over a portion of the full scale of the sensor (2 g >7 g).

FIG. 7 illustrates the repeatability of a measurement.

FIG. 8A shows an example of a sensor to which the invention could be applied.

FIGS. 8B-8D show various steps of preparation of a sensor according to the invention.

FIG. 8E shows a set of different elements of a device for implementing the invention.

FIGS. 9A-9B show steps of a method according to the invention, implemented by a user (FIG. 9A) or by a software (FIG. 9B).

### DETAILED DISCLOSURE OF THE INVENTION

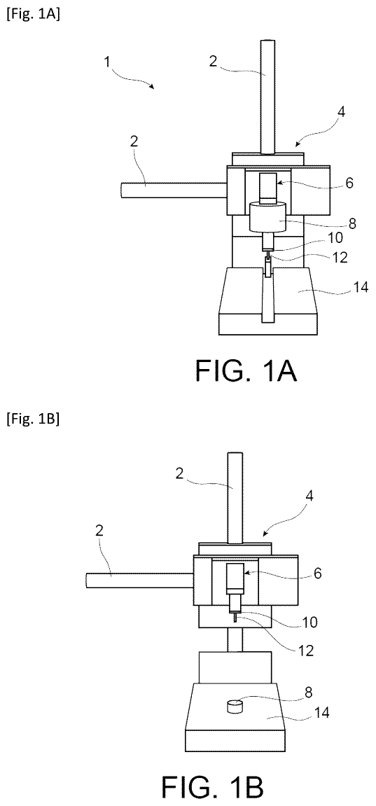

FIG. 1A shows a 1^{st} exemplary embodiment of a device 1 according to the invention. It includes at least one motor 2 or a set of motors 2 (for example: stepper motors) and a system or turntable, preferably three-axis, 4 which carries a post 6 on which means 8 for generating a magnetic field are mounted, for example an electromagnet. A measurement turntable or bench of support 14 is arranged opposite these means 8, which allows positioning and holding a force sensor 12 (shown positioned on the support, but this sensor may be removed from the device according to the invention). Optionally, if this sensor is nonmagnetic, it is provided with a magnetic (or ferroelectric) portion, for example a magnetic screw 10. An example of such a sensor is a piezoresistive sensor, including in particular a Wheastone bridge at the terminals of which a signal could be sampled, which is representative of the stress or of the force applied to the sensor, which is assimilated to a mass or to a force, using the magnetic field generated by the means 8. Thus, it is possible to generate a stress applied directly to the sensor 12, in a contactless fashion, through the use of a magnetic field generated by the means 8 according to an axis XX′; preferably, an axis of sensitivity of the sensor 12 is aligned according to this axis XX′, so that a force is applied to the latter and according to this axis of sensitivity. This force results from the direct interaction of the field directed according to this axis XX′ with the sensor or its magnetic or ferromagnetic portion. For example, a force step enabling calibration of the sensor is generated from the change of state of the magnetic means. It is possible to measure, at the terminals of the sensor, the response of the latter as a function of the stress applied thereto. Hence, it is possible to proceed with a calibration of the sensor.

If the sensor includes several axes of sensitivity, it is possible to perform several measurements, possibly several calibrations, according to these different axes, by modifying the position or the orientation of the latter to switch from alignment, according to the axis XX′, of an axis of sensitivity of the sensor to another.

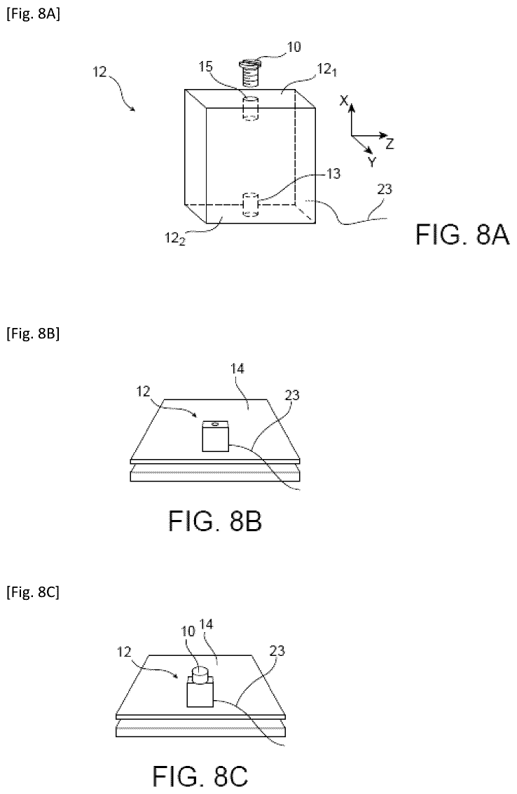

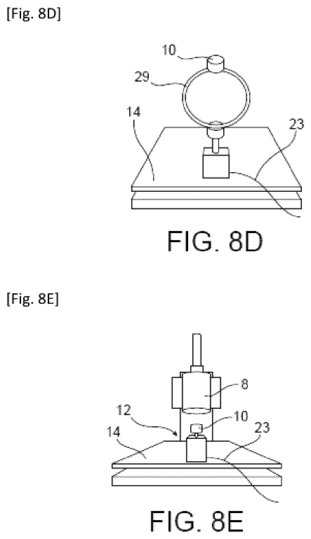

In general, the axis XX′ will be perpendicular to a surface of the support 14 and/or to a surface of the sensor (cf. the explanations hereinbelow with reference to FIG. 8A, FIG. 8B, FIG. 8C, FIG. 8D and FIG. 8E) which is used to apply a stress to the sensor, for example in tension or in compression.

Alternatively, as illustrated in FIG. 1B, the sensor 12 of the device 1 is mounted on the post 6 and the means 8 for generating a magnetic field are mounted on a measurement turntable or bench or support 14 or is part of the latter. The rest of the device, and its operation, are the same as those indicated hereinabove.

In both cases, the means 2, 4, 6 allow carrying out an accurate positioning of the means 8 for generating a magnetic field with respect to the sensor 12. The amplitude of the force or of the force step applied to the sensor may be adjusted according to the distance between the means 8 for generating a magnetic field and the sensor. This distance could be determined with great accuracy, it could be measured and memorized in memory means in order to be associated with a response signal of the sensor for this same distance; by making this distance vary, we know the evolution of the response of the sensor to a stress that thus varies in intensity.

Hence, the stress applied to the sensor using a device according to the invention is accurately directed according to the axis XX′.

Conversely, in the cutting blade technique:
the application of a force perpendicular to the wire, by the action of the blade, could generate a biasing force which also modifies the application of the force at the stressed sensor;
when cutting the wire with a blade, a given amount of wire remains hooked to the sensor and is set in motion, which distorts the final state (the equilibrium position). However, in the context of the present invention, a sensor that interacts directly with a non-movable magnetic element 8 allows better characterizing the final state of the sensor at complete rest. This is a criterion all the more important as the measurement range of the sensor could be small (on a sensor having a measurement range of 10 g for example, a wire length having a mass of 1 g could remain hooked to the sensor and temporarily behave like a spring, which is not negligible). Moreover, in the cutting blade technique, the amount of wire remaining hooked could have its own movement which disturbs the oscillatory response of the entire system.

Means forming a mechanical stop may be implemented, in order to avoid a possible damage of the calibrated sensor, which might come into contact with the means 8 for generating a magnetic field: it is possible, for example, to position a bar between the surface of the support 14 and the means 8, so that the latter is held at a minimum distance from the sensor and does not deteriorate the latter.

Complementarily, or alternatively, the motor(s) 2 may be controlled so that the means 8 could not get close within a given distance with respect to the sensor 12.

In particular, it is possible to implement one or more stepper motor(s) 2, which allow(s) ensuring an accurate centering of the means 8 with respect to the sensor 12; this accuracy is much higher than that obtained in the case of a technique such as the knife technique.

With such a system, an in-situ dynamic calibration is possible, for example on an experimental testing site. Such an example is that of an experimental means allowing applying a brief and high-intensity thermal stress: after calibration in situ (and therefore close to the experimental device) by one of the techniques described in the present application, an object, for example a disc carried by a ring, may be positioned on the sensor in order to be subjected to a considerable heat supply by the experimental device; the constituent material of the object (disc) is degraded and the sensor 12 follows the evolution of this process.

If the considered sensor has a nonmagnetic structure, it is possible to mount, prior to the test and/or to the calibration and/or to the characterization, a magnetic part 10, preferably as least invasive as possible (in particular in terms of mass), for example a magnetic screw.

The invention also allows loading a sensor alternately in tension and then in compression (or vice versa) without modifying the mounting set, without being invasive or dependent on an operator, simply by inversion of the orientation of the magnetic field, for example by inversion of the polarity of the means 8 for generating a magnetic field; on the contrary, the techniques of the prior art require an action of the operator on the system, and in particular on the sensor, between the tension and compression dynamic calibrations.

Thus, compared to the known techniques, and in particular to the “cut-wire” technique, it is possible to carry out one or more complete cycle(s) of (tensile or compressive) stress tests without any intervention of an operator. Hence, it is possible to perform:
a switch from a 1^{st} stress state of the sensor into a 2^{nd} stressed state (by reversing the direction of the magnetic field generated for example by an electromagnet) or into a rest equilibrium state (by cutting the magnetic field generated by the magnetic means, for example the electromagnet);
then optionally a switch from said 2^{nd} stressed state of from the rest state into the 1^{st} stressed state, by generating a force step by operating the magnetic means, for example the electromagnet.

These 2 steps may be carried out in the reverse order.

The invention is easier to implement than the “cut-wire” method: the operator does not waste time hooking the wire, which is often thin, which step also poses repeatability problems since the nodes are never made exactly the same. In addition, the principle of this “cut-wire” method is to tension the sensor using a tensioned wire at the tip of which a mass is positioned; the sensor is then subjected to a static force. Cutting the wire very rapidly releases the mass and thus generates a force step at the sensor which returns to its rest position. Sometimes, it is difficult to cut the tensioned wire very sharply and very briefly (the blade of the cutting element could be substantially blunted), which makes the step rise less abrupt (we are actually never sure that the cut is instantaneous) than a power supply cut-off at an electromagnet 8. Thus, the equilibrium time of the sensor is faster and more accurate by a device or a method according to the invention.

The invention can function at least within the 0.1 N to 1 N (10 g to 100 g) range but may be adapted, subject to the selection of a magnetic means, for example, a suitable electromagnet, to the measurement range of the considered sensor.

One advantage of the invention is to enable a better control of the amplitude of the force step applied to the sensor. Indeed, there is no planarity problem between the surface of the sensor and that of the electromagnet. A device or a method according to the invention involves no friction, no stress wave transmission, while suppressing the additional physical stresses that are generated upon cutting of the wire (“overshoots” in Anglo-Saxon terminology) and the oscillations of this same wire before reaching the equilibrium position of the sensor.

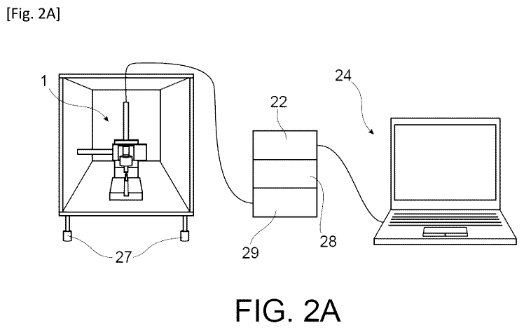

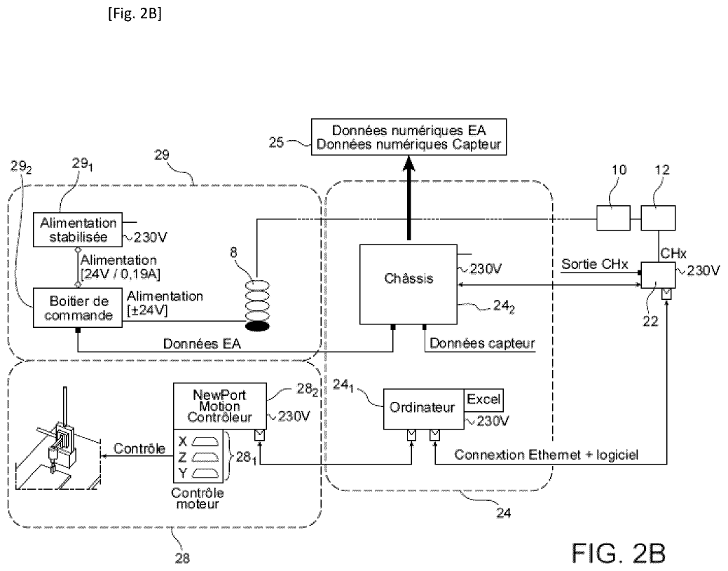

In addition, the invention is easier to implement than the “cut-wire” method over a series of measurements: indeed, unlike the “cut-wire” method, which requires an operation of careful installation and hooking of a wire to a mass which will be different depending on the required force levels to cover the entirety of the measurement range of the sensor, it is possible to carry out repeatability and reproducibility measurements without intervening on the system between the measurements and that being so for the entire measurement range of the sensor. For example, all it needs is to progressively modify the distance between the electromagnet and the sensor and to repeat the measurement(s) for each of the selected distances. This may be done thanks to the motor(s) 2 and to the means 4, 6, which may be driven by various means as explained hereinbelow with reference to FIGS. 2A and 2B.

FIG. 2A shows a device according to an embodiment of the invention, equipped with its measurement chain. The device 1 is connected to power supply and amplification means 22 dedicated to the tested sensor, to means 28 for driving the motors 2 and to means 29 for driving the electromagnet 8. The signal generated by the sensor may be digitized and processed by processing means 24, for example in a software form in a processor or a computer or a microcomputer programmed to this end. For example, the measured temporal signal may undergo a Fourier transform processing to identify the characteristic frequenc (y/ies) of the sensor.

The entire device, including the support 12 and the electromagnet 8 may be mounted on feet 27 including damping means, for example made of rubber, to neutralize any external vibration.

FIG. 2B allows visualizing the different relationships and/or wiring in a mounting such as that of FIG. 2A.

The means 28 for driving the motor(s) are controlled by the computer 24. These means may include a controller 28₂ (connected to the computer 24 by an Ethernet connection) and specific means 28₁ for controlling the motor along each of the axes X, Y, Z.

The means 29 for driving the electromagnet 8 include a regulated power supply 29₁ and a control box 29₂ of the electromagnet. The latter produces the magnetic field which acts on the magnetic material (or on the magnetic screw 10).

The means 24 include the computer 24₁ as such and a frame 24₂ for acquiring data. The data relating to the electromagnet and the data originating from the sensor 12 are sent to the data acquisition frame 24₂, which produces corresponding digital data 25.

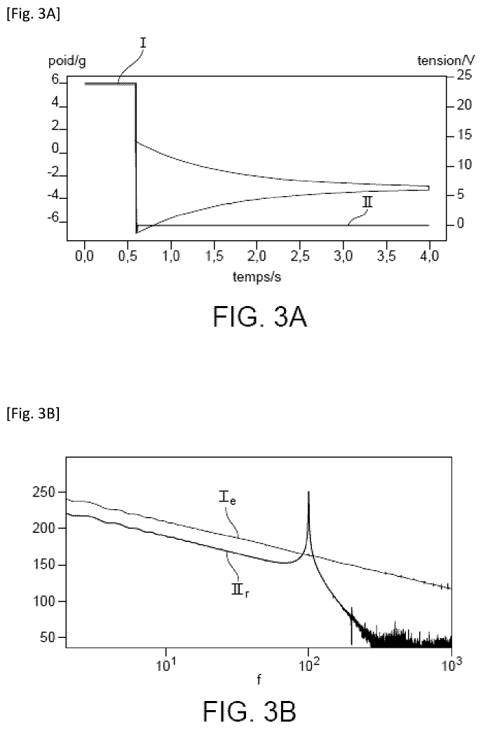

FIG. 3A shows on the one hand the setpoint applied to the electromagnet 8 (with a state change) and the oscillatory response of the system to be characterized. The setpoint or the state of the electromagnet 8 is characterized by the levels I and II shown in this figure: a stress step is applied, by passage from the level I to the level II, to the sensor 12 to be calibrated or qualified. The temporal oscillatory response of the latter is shown in this same figure. FIG. 3B shows this same response in frequency terms (curve IIᵣ, the curve Iₑ representing the excitation frequency), it therefore consists of the transfer function of the system.

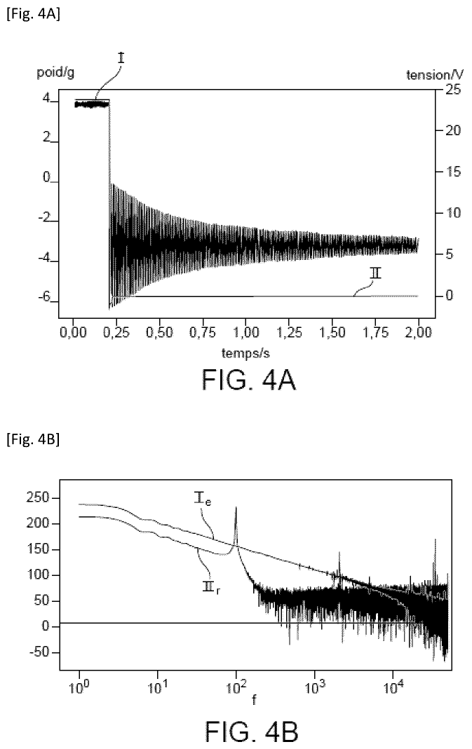

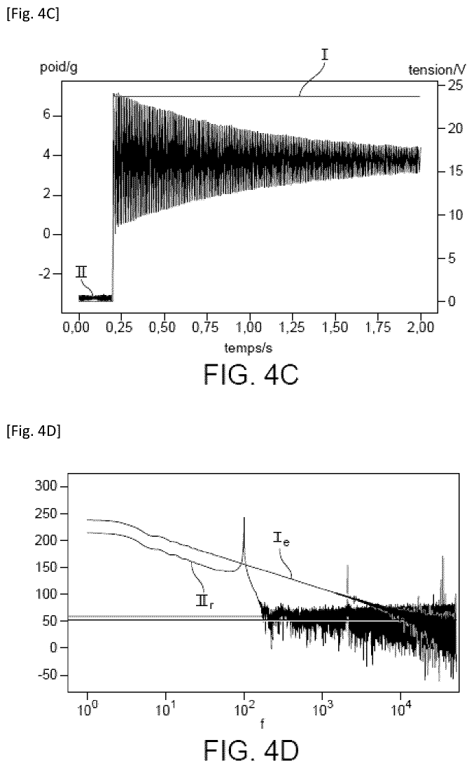

FIGS. 4A-4D show the comparison of the temporal (FIGS. 4A and 4C) and frequency (FIGS. 4B and 4D, wherein the curve II, shows the response of the sensor, the curve le showing the excitation frequency) signals for a compressive-type load:

a) FIGS. 4A-4B: a 4 g load is first applied and then unloading to −2.5 g (which corresponds, in this example, to the “off-load” final state, due to the mass of the magnetized screw; the same applies for the other FIGS. 4B-4D); one could recognize, in FIG. 4A, the 2 states I and II of the step applied by the electromagnet;

b) FIGS. 4C-4D: the “off-load” initial state is at −2.5 g and then unloading to 4 g (final state) is carried out. In this case, the force is reversed compared to the previous figures, since we switch from the state II into the state I.

The power supply setpoint of the electromagnet herein amounts to 24 V: the “off-load” state, i.e. generating no stress on the sensor (state II) being for a 0 V power supply, the stress setting state (state I) for a 24 V power supply.

These FIGS. 4A-4D show that it is possible to test the response of the sensor when loaded or unloaded for example by switching from an initial state into a final state or from a final state into an initial state by simply changing the polarity of the electromagnet. There is no other modification of the device to be made, which guarantees identical and constant measurement conditions from one measurement to another.

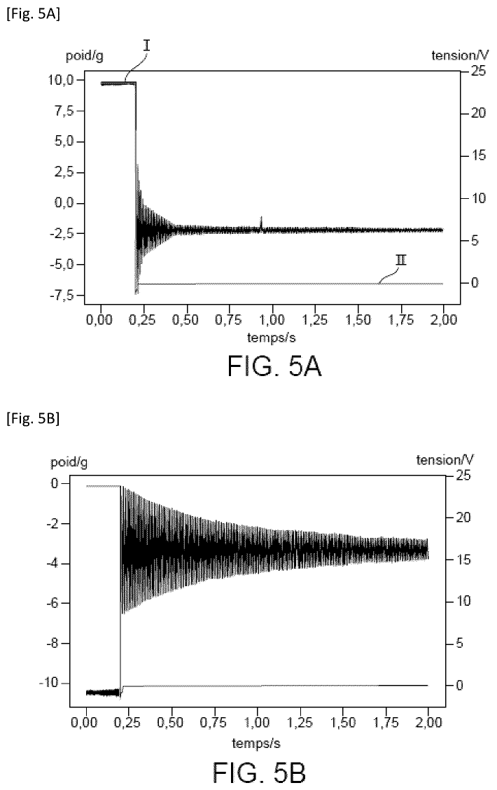

FIGS. 5A-5B show temporal signals obtained for a load:
in compression (FIG. 5A) at 10 g, followed by unloading to −2.5 g (“off-load” state);
or in tension (FIG. 5B) at −10 g, followed by unloading to −2.5 g (off-load state). Herein again, one could recognize, in FIG. 5A, the 2 states I and II of the step applied by the electromagnet 8.

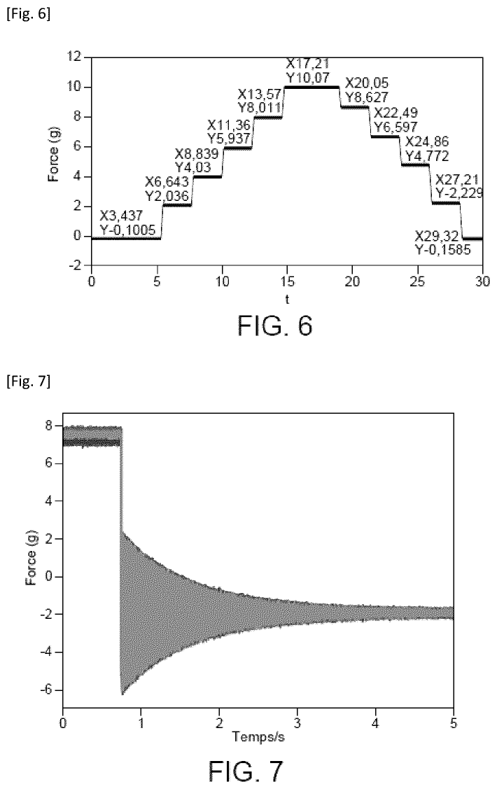

FIG. 6 shows the evolution of the mass variation (vertical axis, in g) experienced by the sensor 12, as a function of the movement of the electromagnet (according to 2 axes X and Y perpendicular to one another), over a portion of the full scale of the sensor (in this example: from 2 g to 7 g). This figure shows very well the presence of a hysteresis of the sensor. Hence, by measuring the response of the sensor in compression, and then in tension, or vice versa, the invention allows identifying such a hysteresis. Hence, it allows identifying data of the hysteresis curve of the sensor.

FIG. 7 illustrates the repeatability of a measurement according to the invention. 50 tests have been carried out on a sensor with a 10 g measurement range. The duration of each test is 5 seconds, and sampling is at 1 kHz (number of points: 5,000).

The maximum (respectively: minimum) value of the standard deviation is 0.14 (respectively: 0.0085), and its average is 0.0233.

Hence, the repeatability noticed for the same measurement according to the invention is very good.

FIG. 8A shows an example of a sensor 12 to which a device according to the invention or a method according to the invention could be applied. It includes a case, for example having a substantially parallelepiped shape, which contains a piezoresistive element associated with a Wheastone bridge. The invention may be used on sensors enabling mass or weight measurements. It may be used on capacitive, or piezoresistive, or piezoelectric type sensors, such as a balance. The upper face 12₁ and/or the lower face 12₂ may be used to subject the sensor to a tensile or compressive stress, an axis of sensitivity of the sensor being directed along the X axis substantially perpendicular to each of these faces 12₁, 12₂. The sensor may include one or 2 other ax (is/es) of sensitivity, for example according to the Y and/or Z axis, perpendicular to each other and to the X axis, in which case either one of the faces perpendicular to at least one of these Y, Z axes may be used to perform tension or compression measurement according to the selected axis. One or more of the used faces may be provided with a hole 13, 15, so as to be able to apply the stress to be measured. For example, these consist of threaded holes. The hole 13 may be used in particular to fasten the sensor 12 on the baseplate 14 (FIG. 1A) or on the post 6 (FIG. 1B). The hole 15 may be used to insert an element, for example a screw 10, made of a magnetic or ferromagnetic material, if the entire sensor is nonmagnetic and in order to implement a method according to the invention.

One or more wire(s) 23 (cf. FIGS. 8B-8E) allow(s) sampling signals representative of the stresses applied to the sensor 12. A cowling (not shown) allows protecting the bench object of the invention from surrounding disturbances (air stream, temperature variations) during the performed measurements.

FIGS. 8B-8D show:
the support 14 and the sensor 12 (FIG. 8B);
an example of fastening of a magnetic screw 10 (FIGS. 8B and 8C), with, in the case of FIG. 8C, the addition of an accessory (herein a ring) 31.

The sensor 12 is first screwed onto the metal support 14 (FIG. 8B), and then the magnetic screw 10 (FIG. 8C) or the ring 31 and magnetic screw 10 assembly (FIG. 8D) is added.

FIG. 8E shows a view of the alignment between the different elements of the device: the support 14, the sensor 12 herein with the magnetic screw (element 10), and the electromagnetic 8.

In an example of implementation of a method according to the invention, which method may implement a device as described in the present application, the magnetic field B is applied according to the X axis, in either direction, and interacts directly either with the entire sensor 12, or with the element 10, in order to subject this sensor to the desired tensile or compressive stress. For example, the response of the sensor may be measured according to the distance between the means 8 for generating the magnetic field and the sensor.

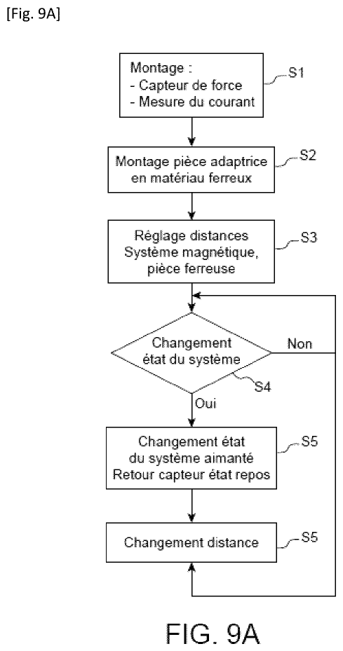

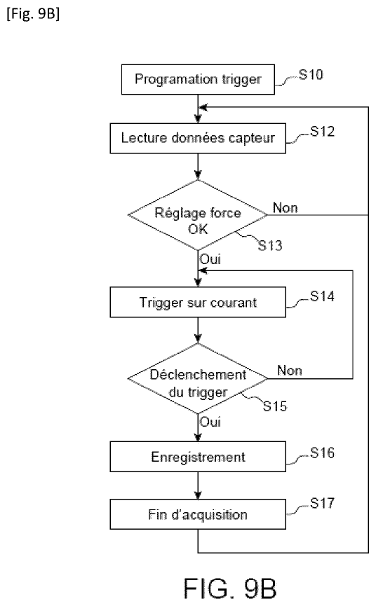

FIG. 9A shows steps of implementation of an example of a method according to the invention, for example for characterizing the transfer function.

In a 1^{st} step (S1), the force sensor 12 is mounted, for example in a mounting according to one of FIGS. 1A or 1B; it is possible to set the setpoint measurement for the operation of the electromagnet (herein, the current applied to the electromagnet 8).

In a 2^{nd} step (S2), it is possible to mount an adaptation part 10 made of a ferrous material (for example in the case where the sensor 12 is nonmagnetic), or an accessory 29 on the sensor 12. If this accessory part 29 is nonmagnetic, an adapter part 10 made of a ferrous material should be mounted.

The distance between the magnetic system and the sensor 12 may be set and/or measured accurately, for example using a stepper motor (step S3). Centering between the magnetic system 8 and the sensor may be ensured in a plane (YZ) by a turntable driven by two stepper motors.

Initially, the system, essentially including the sensor 12, is in a given state, dependent on the application, or not, of a magnetic field according to the axis XX′. When it is decided to change the state of the system (step S4), the latter switches, for example, from a stressed state (in tension or in compression) into a rest state (step S5): such a switch, from a^{1st} state to a 2^{nd} state, is illustrated in FIGS. 3A, 4A, 4C or 5A already commented hereinabove. A measurement of the response of the system, for example according to one of these FIGS. 3A, 4A, 4C or 5A, could then be carried out. The signal thus measured may be subjected to one or more processing(s), in particular a Fourier transform in order to identify the spectrum of its response and, for example identify one or more resonance frequenc (y/ies).

Afterwards, it is possible to modify the distance between the electromagnet and the sensor 12 (step S6) and then for example return back to the setting of step S3. Regardless of the implemented embodiment, the response data of the sensor may be memorized, for example according to the distance between the electromagnet and the sensor. Optionally, it is possible to collect response data of the sensor according to the temperature, which could be interesting for use of the device within a given temperature range.

Thus, it is possible to memorize, for one or more sensor(s), response data and/or data from hysteresis curve(s).

Steps of a software for implementing a method according to the invention are illustrated in FIG. 9B.

In a 1^{st} step (S10), the triggering level of the means for measuring a signal originating from the sensor 12 may be programmed.

Afterwards (step S12), the data of the sensor are read).

Afterwards, the applied force may be set (step S13), for example according to the level of the current that flows in the electromagnet, and, if this setting is satisfactory, it is possible to trigger this current (step S14) as well as the acquisition of the data (step S15). Afterwards, it is proceeded with recording of these data (step S16). This is the end of the acquisition (step S17).

1-22. (canceled)

23. A device for characterizing a force sensor, comprising:
magnetic means for generating a magnetic field according to at least one axis;
means for adjusting and then holding a relative position, according to the axis, between a sensor to be tested and the magnetic means; and
means for measuring a signal representative of a tensile or compressive force applied to the sensor directly using said magnetic means.

24. The device according to claim 23, including a fixed support for holding the sensor to be characterized and a movable support for holding the magnetic means.

25. The device according to claim 24, the movable support being driven by a 3-axis system controlled by 3 motors.

26. The device according to claim 23, the means for generating a magnetic field including an electromagnet.

27. The device according to claim 23, further including means for:
at least reversing the direction of application of the magnetic field along the direction (XX′);
and/or cutting off the application of the magnetic field along the axis (XX′).

28. The device according to claim 23, further including means for limiting the distance between the magnetic means and a sensor to a minimum distance.

29. The device according to claim 23, the means for adjusting and then holding a relative position, according to said axis, between a force sensor to be characterized and the magnetic means, including at least one motor, for example a stepper motor.

30. The device according to claim 23, further including means for centering and/or holding and/or measuring a relative position according to axes which are perpendicular to one another and to said axis, between the sensor to be characterized and the magnetic means.

31. The device according to claim 23, further including means for digitizing, and/or processing, for example by Fourier transform, a signal sampled at the terminals of a sensor to be characterized.

32. The device according to claim 23, further including means for digitizing and/or memorizing reply data and/or of calibration and/or hysteresis of a sensor to be characterized.

33. A method for characterizing a sensor, the method comprising:
fixedly holding said sensor with respect to means for generating a magnetic field;
generating a magnetic field according to a direction enabling the application of a tension or a compression to the sensor, by direct interaction between this field and the sensor; and
measuring the response of the sensor to this tension or compression.

34. The method according to claim 33, further including at least one of:
a prior step of mounting a magnetic part on the sensor, if the sensor is nonmagnetic;
a step of mounting an accessory forming a support, for example a ring, on the sensor;
a prior step of mounting a magnetic part on the accessory.

35. The method according to claim 33, further including modifying or adjusting the spacing between the means for generating a magnetic field and said sensor.

36. The method according to claim 33, including applying to the sensor:
alternately a tensile and then compressive stress force, by reversing the direction of the magnetic field;
or a tensile or compressive stress, and then no stress.

37. The method according to claim 33, the tension or the compression being applied according to a 1^{st} axis of sensitivity of the sensor.

38. The method according to claim 37, the sensor including at least a 2^{nd} axis of sensitivity, the method further including:
a step of modifying the orientation of the sensor,
and applying a tension or a compression according to this 2^{nd} axis of sensitivity of the sensor;
measuring the response of the sensor to this tension or compression according to this 2^{nd} axis of sensitivity.

39. The method according to claim 33, the sensor being of the piezoresistive or capacitive, or piezoelectric type or including a scale or a weighing machine or a balance.

40. The method according to claim 33, the sensor including one or more face(s), the direction of the magnetic field being perpendicular to this or these face(s).

41. The method according to claim 33, the implemented stress being comprised between 1/10 Newton and 1 Newton or more than 1 Newton.

42. The method according to claim 33, further including a step of memorizing response and/or calibration and/or hysteresis data of the sensor at said tension or compression, for example according to a position of the sensor with respect to means that generate said magnetic field.
